(19) United States
(12) Patent Application Publication
(10) Pub. No.: US 2007/0203050 A1
(43) Pub. Date: Aug. 30, 2007

(54) Synergistic Surfactant Mixtures With Higher Dynamic Properties And Lower Cmc

(75) Inventors: Gunter Oetter, Frankenthal (DE); Stephan Hess, Mannheim (DE); Ulrich Steinbrenner, Neustadt (DE); Jurgen Tropsch, Romerberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/578,140

(22) PCT Filed: Apr. 28, 2005
(86) PCT No.: PCT/EP05/04571

§ 371 Date: Oct. 10, 2006

(30) Foreign Application Priority Data
Apr. 29, 2004 (DE) 10 2004 021 208.2

(51) Int. Cl. C11D 17/00

(52) U.S. Cl. 510/424; 510/490

(57) ABSTRACT

The present invention relates to a surfactant mixture of at least one anionic surfactant and at least one amphoteric surfactant, to a solution consisting of 0.01-40% by weight of such a surfactant mixture, 60-99.99% by weight of water and 0-5% by weight of additives, to the use of surfactant mixtures of at least one anionic surfactant and at least one amphoteric surfactant or of at least one nonionic surfactant and at least one amphoteric surfactant for reducing the critical micelle formation concentration, increasing the rate of wetting and improving the adsorption at interfaces in detergents, cleaning compositions, dishwashing compositions, coatings, humectants, emulsions, suspensions, leveling assistants or formulations for the treatment of leather and/or textiles, and to cleaning compositions comprising surfactant mixtures of the Na salt of di-2-ethylhexyl sulfosuccinate and myristyl- and/or lauryldimethylamine oxide or isotridecanol which is ethoxylated with 3 to 7 equivalents of ethylene oxide, and myristyl- and/or lauryidimethylamine oxide.

The present invention relates to a surfactant mixture consisting of at least one anionic surfactant and at least one amphoteric surfactant, to a surfactant mixture consisting of isotridecanol which is alkoxylated with ethylene oxide, and myristyl- and/or lauryldimethylamine oxide, to the use of corresponding surfactant mixtures for reducing the micelle concentration, increasing the rate of wetting and improving the adsorption at interfaces, and to cleaning compositions comprising the surfactant mixtures according to the invention.

The provision of highly dynamic surfactant systems is a central aim in many areas. Alcohols such as ethanol and isopropanol are often used in order to adjust the surface tension of the solvent water to low values and thus to bring with them the prerequisite for rapid wetting. However, due to their volatility, the alcohols are a problem for humans and the environment. The very good wetting effect of hydrophobic alcohols which can be produced from acetylenes and aldehydes is known. As commercial products, they are on the market, for example, under the name Surfynol®. These molecules do not form micelles and are thus not able to release, emulsify or solubilize hydrophobic substances from surfaces.

All effective wetting agents generally exhibit a low aggregation tendency, i.e. low tendency to form micelles. These substances cannot therefore be used simultaneously for applications such as washing and cleaning where the existence of micelles is a prerequisite.

Mixtures of different surfactants in combination with further substances are known from the prior art.

U.S. Pat. No. 4,276,205 discloses a surfactant composition with improved cleaning power in cold water, comprising an amine oxide, an ethoxylated alcohol or an ethoxylated alkylphenol and a condensation product of C₂-C₄-alkylene oxides with a molecular weight of from 2000 to 40 000 g/mol.

U.S. Pat. No. 4,405,483 discloses a liquid cleaning composition comprising a surfactant, an aluminosilicate ion-exchanging material, a stabilizing agent and a polymeric compound which absorbs calcium and magnesium ions in water.

WO 99/19438 discloses an aqueous cleaning composition which is free from anionic surfactants and which comprises linear ethoxylated alcohols and an amine oxide or a betaine. As optional component, the composition comprises, for example, cationic ammonium compounds.

Surfactant mixtures which comprise combinations of specified ethoxylated zwitterionic compounds with other cleaners, disclosed in U.S. Pat. No. 3,929,678, are suitable for the removal of soilings.

EP 0 347 199 A2 discloses aqueous shampoo compositions which comprise sodium or ammonium dialkyl sulfosuccinates and antimicrobially effective compounds such as 1-hydroxy-2-pyrridone and 1-imidazoyl-2-butanone or derivatives thereof.

DE 199 18 267 A1 discloses a hand dishwashing composition in which the sensitive ingredients are incorporated into a thermally stable, storage-stable and transport-stable, easy-to-handle form. This is achieved by a thickened surfactant-containing agent which comprises anionic and amphoteric surfactants, polymers and microcapsules.

Processes such as the application of crop protection compositions, the painting of car bodies with aqueous pigment dispersions, metal working, paper making and textile manufacturing, inks and paints, are based on rapid spraying and wetting processes. In order to be able to control these operations in aqueous-based formulations, highly dynamic surfactants are required which can reduce the surface tension and interface tension within milliseconds. These surfactants are generally amphiphiles with a short alkyl chain or branched structures; as a rule structures with high micelle formation concentration and thus a high concentration of molecules not bonded micellarly. This is associated with rapid diffusion at the interface, formation of an interfacial film and reduction in the interfacial energy as prerequisite for effective wetting and the formation of small droplets upon spraying. Since these structures generally have a high micelle formation concentration, the prerequisite for simultaneous emulsification, solubilization, for example in order to remove oily soiling in washing and cleaning processes, is not complied with at low use concentrations.

Surfactants have the property of positioning themselves at interfaces and reducing the interfacial energy between two phases. They consist of a hydrophilic molecular moiety and a hydrophobic molecular moiety, the surfactant molecules positioning themselves in aqueous solution with increasing surfactant concentration at the interface until it is completely covered. Above a certain concentration, the surfactants which remain free in the solution form agglomerates, which are called micelles. This limiting concentration is referred to as critical micelle formation concentration (cmc), i.e. above this concentration the surfactants form micelles.

The reasons for the low dynamics of surfactants which are present in micelle form at the use concentration can be diverse. One reason may be the stability of the micelles, meaning that the supply of freely dissolved surfactants from the micelle association does not take place quickly enough. In addition, it is known that micelles diffuse more slowly and thus reach an interface later than do individual molecules. Furthermore, an adsorption barrier for micelles at interfaces may be the reason for the low dynamics. The dynamic disadvantages which are associated with the presence of micelles can be circumvented if it is possible to increase the rate of degradation of micelles or the supply of individual surfactants from the micelle aggregates.

A problem of the surfactants and mixtures of surfactants known from the prior art is that they are either highly dynamic and thus absorb rapidly at interfaces, form an interfacial film and thereby reduce the interfacial energy, or that they have a low micelle formation concentration, meaning that the prerequisites for emulsification, solubilization or soil release are complied with. Since these two prerequisites are not present at the same time, the known surfactants and/or surfactant mixtures can only be used in a limited field of use.

It is an object of the present invention to provide surfactant mixtures which are highly dynamic and thus adsorb rapidly at interfaces, form an interfacial film and thereby reduce the interfacial energy. These surfactant mixtures should also have a low micelle formation concentration, meaning that additionally the prerequisite for emulsification, solubilization or soil release is complied with, and the surfactant systems can thus be used over a relatively wide field of use.

We have found that this object is achieved according to the invention by a surfactant mixture consisting of at least one anionic surfactant and at least one amphoteric surfactant.

The present invention provides a surfactant mixture consisting of
10 to 90% by weight of at least one anionic surfactant and
10 to 90% by weight of at least one amphoteric surfactant,
   where the sum is 100% by weight.

The constituents of the surfactant mixture according to the invention are explained below:

Anionic Surfactants

Anionic surfactants are interface-active compounds with one or more functional anion-active groups which dissociate in aqueous solution to form anions which are ultimately responsible for the interface-active properties.

Anionic surfactants which can be used in the surfactant mixture according to the invention can be chosen from organic, sulfur-containing compounds, preferably chosen from the group consisting of C₁-C₁₆-alkylbenzenesulfonates, C₁-C₂₀-alkanesulfonates, C₂-C₂₀-olefinsulfonates, di-C₁-C₂₀-alkyl sulfosuccinates, di-C₁-C₂₀-alkylphenol sulfosuccinates, primary and secondary C₁-C₂₀-alkyl sulfates, C₁-C₂₀-alkyl polyether ethoxysulfates having 1 to 25 ethoxy groups and mixtures thereof, these anionic surfactants being present in the form of their alkali metal, ammonium, C₁-C₆-alkanolamine or C₁-C₆-alkylamine salts or mixtures thereof.

As anionic surfactants, particular preference is given to using the alkali metal, alkaline earth metal and ammonium salts of di-C₁-C₂₀-alkyl sulfosuccinates or di-C₁-C₂₀-alkylphenol sulfosuccinates in the surfactant mixture according to the invention.

The di-C₁-C₂₀-alkyl sulfosuccinates used particularly preferably as anionic surfactants correspond to the formula (I) 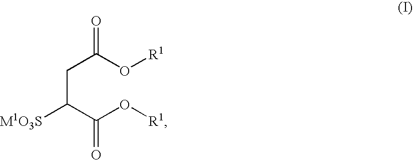
in which M¹ and R¹ have the following meanings:
R¹: linear or branched, saturated or unsaturated C₁-C₂₀-radical, preferably linear or branched, saturated C₁-C₁₀-alkyl radical, very particularly preferably monobranched C₈-alkyl radical,
M¹: alkali metal, alkaline earth metal or ⁺NR²₄ where
   R²: independently of the others, is hydrogen or linear or branched C₁-C₆-alkyl radical,
   preferably an alkali metal chosen from the group consisting of Li, Na and K.

If M¹ is alkaline earth metal, then the corresponding cation and the anion are in the ratio 1:2, resulting in charge neutrality.

The anionic surfactant used in the surfactant mixture according to the invention is particularly preferably the Na salt of di-2-ethylhexyl sulfosuccinate.

The anionic surfactants which can be used in the surfactant mixture according to the invention can be prepared by processes known to the person skilled in the art.

Amphoteric or Zwitterionic Surfactants

The terms amphoteric surfactants and zwitterionic surfactants are used interchangeably in this specification.

In the surfactant mixture according to the invention, the amphoteric surfactants which may be used are all surface-active substances with at least two functional groups which can ionize in aqueous solution and thereby impart anionic or cationic character to the surface-active compounds, depending on the conditions of the medium.

The amphoteric surfactants which can be used in the mixture according to the invention include betaines, amine oxides, alkylamidoalkylamines, alkyl-substituted amino acids, acetylated amino acids or surfactants of natural origin, such as lecithins or saponins.

Betaines

Suitable betaines are the alkylbetaines, the alkylamidobetaines, the imidazoliniumbetaines, the sulfobetaines, and the phosphobetaines and preferably satisfy formula (II),
R³—[CO—X—(CH₂)ₙ]ₓ—N⁺(R⁴)(R⁵)—(CH₂)ₘ—[CH (OH)—CH₂]_{y}—Y⁻ (II),
in which

R³ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

X is NH, NR⁶ with the C₁₋₄-alkyl radical R⁶, O or S,

n is a number from 1 to 10, preferably 2 to 5, in particular 3,

x is 0 or 1, preferably 1,

R⁴, R⁵, independently of one another, are a C₁₋₄-alkyl radical, optionally hydroxy-substituted, such as, for example, a hydroxyethyl radical, in particular a methyl radical, m is a number from 1 to 4, in particular 1, 2 or 3,

y is 0 or 1 and

Y is COO, SO₃, OPO(OR⁷)O or P(O)(OR⁷)O, where R⁷ is a hydrogen atom or a C₁₋₄-alkyl radical.

The alkyl- and alkylamidobetaines, betaines of the formula (II) with a carboxylate group (Y═COO⁻) are also called carbobetaines.

Further amphoteric surfactants are the alkylbetaines of the formula (III), the alkylamidobetaines of the formula (IV), the sulfobetaines of the formula (V) and the amidosulfobetaines of the formula (VI),
R³—N⁺(CH₃)₂—CH₂COO⁻ (III)
R³—CO—NH—(CH₂)₃—N⁺(CH₃)₂—CH₂COO⁻ (IV)
R³—N⁺(CH₃)₂—CH₂CH(OH)CH₂SO₃⁻ (V)
R³—CO—NH—(CH₂)₃—N⁺(CH₃)₂CH₂CH(OH)CH₂SO₃⁻ (VI)
in which R³ has the same meaning as in formula (II).

Examples of suitable Betaines and Sulfobetaines are the following compounds (INCl-identifier): Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PB-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamidopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine.

Amine Oxides

The amine oxides suitable according to the invention as amphoteric surfactants include alkylamine oxides, in particular alkyldimethylamine oxides, alkylamidoamine oxides and alkoxyalkylamine oxides. Preferred amine oxides satisfy formulae (VII) and (VIII),
R⁸R⁹R¹⁰N⁺O⁻ (VII)
R⁸—[CO—NH—(CH₂)_{w}]_{z}—N⁺(R⁹)(R¹⁰)—O⁻ (VIII)
in which R⁸ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₅-alkyl radical, which is bonded to the nitrogen atom N in the alkylamidoamine oxides via a carbonylamidoalkylene group —CO—NH—(CH₂)_{z}— and in the alkoxyalkylamine oxides via an oxaalkylene group —O—(CH₂)_{z}, where z in each case is a number from 1 to 10, preferably 2 to 5, in particular 3,

R⁹, R¹⁰ independently of one another, is a C₁₋₄-alkyl radical, optionally hydroxy-substituted, such as, for example, a hydroxyethyl radical, in particular a methyl radical.

Examples of suitable amine oxides are the following compounds (INCl-identifier): Almondamidopropylamine Oxide, Babassuamidopropylamine Oxide, Behenamine Oxide, Cocamidopropylamine Oxide, Cocamine Oxide, Coco-Morpholine Oxide, Decylamine Oxide, Decyltetradecylamine Oxide, Diaminopyrimidine Oxide, Dihydroxyethyl-C₈₋₁₀-Alkoxypropylamine Oxide, Dihydroxyethyl-C₉₋₁₁-Alkoxypropylamine Oxide, Dihydroxyethyl-C₁₂₋₁₅-Alkoxypropylamine Oxide, Dihydroxyethyl Lauramine Oxide, Dihydroxyethyl Stearamine Oxide, Dihydroxyethyl Tallowamine Oxide, Hydrogenated Palm Kernel Amine Oxide, Hydrogenated Tallowamine Oxide, Hydroxyethyl Hydroxypropyl-C₁₂₋₁₅-Alkoxypropylamine Oxide, Isostearamidopropylamine Oxide, Isostearamidopropyl Morpholine Oxide, Lauramidopropylamine Oxide, Lauramine Oxide, Methyl Morpholine Oxide, Milkamidopropyl Amine Oxide, Minkamidopropylamine Oxide, Myristamidopropylamine Oxide, Myristamine Oxide, Myristyl/Cetyl Amine Oxide, Oleamiopropylamine Oxide, Oleamine Oxide, Olivamidopropylamine Oxide, Palmitamidopropylamine Oxide, Palmmitamine Oxide, PEG-3 Lauramine Oxide, Potassium Dihydroxyethyl Cocamine Oxide Phosphate, Potassium Triphosphonomethylamine Oxide, Sesamidopropylamine Oxide, Soyamidopropylamine Oxide, Stearamidopropylamine Oxide, Stearamine Oxide, Tallowamidopropylamine Oxide, Tallowamine Oxide, Undecylenamidopropylamine Oxide, Wheat Germamidopropylamine Oxide, Cocoyldimethylamine Oxide, Lauryldimethylamine Oxide, Decyidimethylamine Oxide and Myristyldimethylamine Oxide.

Alkylamidoalkylamines

The alkylamidoalkylamines are amphoteric surfactants of the formula (IX),
R¹¹—CO—(NR¹²—(CH₂)ᵢ—N(R¹³)—(CH₂CH₂O)ⱼ—(CH₂)ₖ—[CH(OH)]ₗ—CH₂-Z-OM² (IX)
in which R¹¹ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₃-alkyl radical,

R¹² is a hydrogen atom H or a C₁₋₄-alkyl radical, preferably H,

i is a number from 1 to 10, preferably 2 to 5, in particular 2 or 3,

R¹³ is hydrogen or CH₂COOM² (for M² see below),

j is a number from 1 to 4, preferably 1 or 2, in particular 1,

k is a number from 0 to 4, preferably 0 or 1,

l is 0 or 1,

Z is CO, SO₂, OPO(OR¹⁴) or P(O)(OR¹⁴), where R¹⁴ is a C₁₋₄-alkyl radical or is M² (see below), and

M² is a hydrogen atom, an alkali metal, an alkaline earth metal or a protonated alkanolamine, e.g. protonated mono-, di- or triethanolamine.

Preferred representatives satisfy the formulae (X) to (XIII),
R¹¹—CO—NH—(CH₂)₂—N(R¹³)—CH₂CH₂O—CH₂—COOM² (X)
R¹¹—CO—NH—(CH₂)₂—N(R¹³)—CH₂CH₂O—CH₂CH₂—COOM² (XI)
R¹¹—CO—NH—(CH₂)₂—N(R¹³)—CH₂CH₂O—CH₂CH(OH)CH₂—SO₃M² (XII)
R¹¹—CO—NH—(CH₂)₂—N(R¹³)—CH₂CH₂O—CH₂CH(OH)CH₂—OPO₃HM (XIII)
in which R¹¹, R¹³ and M² have the same meaning as in formula (IX).

Examples of alkylamidoalkylamines are the following compounds (INCl-identifier): Cocoamphodipropionic Acid, Cocobetainamido Amphopropionate, DEA-Cocamphodipropionate, Disodium Caproamphodiacetate, Disodium Caproampho-dipropionate, Disodium Capryloamphodiacetate, Disodium Capryloamphodipropionate, Disodium Cocoamphocarboxyethylhydroxypropylsulfonate, Disodium Cocampho-diacetate, Disodium Cocamphodipropionate, Disodium Isostearoamphodiacetate, Disodium Isostearoamphodipropionate, Disodium Laureth-5 Carboxyamphodiacetate, Disodium Lauroamphodiacetate, Disodium Lauroamphodipropionate, Disodium Oleoamphodipropionate, Disodium PPG-2-lsodeceth-7 Carboxyamphodiacetate, Disodium Stearoamphodiacetate, Disodium Tallowamphodiacetate, Disodium Wheatgermamphodiacetate, Lauroamphodipropionic Acid, Quaternium-85, Sodium Caproamphoacetate, Sodium Caproamphohydroxypropylsulfonate, Sodium Caproamphopropionate, Sodium Caprylamphoacetate, Sodium Caprylamphohydroxypropylsulfonate, Sodium Caprylamphopropionate, Sodium Cocoamphoacetate, Sodium Cocoamphohydroxypropylsulfonate, Sodium Cocoamphopropionate, Sodium Cornamphopropionate, Sodium Isostearoamphoacetate, Sodium Isostearoamphopropionate, Sodium Lauroamphoacetate, Sodium Lauroamphohydroxypropylsulfonate, Sodium Laurompho PG-Acetate Phosphate, Sodium Lauroamphopropionate, Sodium Myristoamphoacetate, Sodium Oleoamphoacetate, Sodium Oleomphohydroxypropylsulfonate, Sodium Oleoamphopropionate, Sodium Ricinoleoamphoacetate, Sodium Stearoamphoacetate, Sodium Stearoamphohydroxypropylsulfonate, Sodium Stearoamphopropionate, Sodium Tallamphopropionate, Sodium Tallowamphoacetate, Sodium Undecylenoamphoacetate, Sodium Undecylenoamphopropionate, Sodium Wheat Germamphoacetate and Trisodium Lauroampho PG-Acetate Chloride Phosphate.

Alkyl-Substituted Amino Acids

Alkyl-substituted amino acids preferred according to the invention are monoalkyl-substituted amino acids according to formula (XIV),
R¹⁵—NH—CH(R¹⁶)—(CH₂)ᵤ—COOM³ (XIV)
in which R¹⁵ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

R¹⁶ is hydrogen or a C₁₄-alkyl radical, preferably H,

u is a number from 0 to 4, preferably 0 or 1, in particular 1, and

M³ is hydrogen, an alkali metal, an alkaline earth metal or a protonated alkanolamine, e.g. protonated mono-, di- or triethanolamine, alkyl-substituted imino acids according to formula (XV),
R¹⁷—N—[(CH₂)ᵥ—COOM⁴]₂ (XV)
in which R¹⁷ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

v is a number from 1 to 5, preferably 2 or 3, in particular 2, and

M⁴ is hydrogen, an alkali metal, an alkaline earth metal or a protonated alkanolamine, e.g. protonated mono-, di- or triethanolamine, where M⁴ in the two carboxyl groups can have the same meaning or two different meanings, e.g. may be hydrogen and sodium or two times sodium,

and mono- or dialkyl-substituted natural amino acids according to formula (XVII),
R¹⁸—N(R¹⁹)—CH(R²⁰)—COOM⁵ (XVI)
in which R¹⁸ is a saturated or unsaturated C₆₋₂₂-alkyl radical, preferably C₈₋₁₈-alkyl radical, in particular a saturated C₁₀₋₁₆-alkyl radical, for example a saturated C₁₂₋₁₄-alkyl radical,

R¹⁹ is hydrogen or a C₁₋₄-alkyl radical, optionally hydroxy- or amine-substituted, e.g. a methyl, ethyl, hydroxyethyl or aminopropyl radical,

R²⁰ is the radical of one of the 20 natural α-amino acids H₂NCH(R²⁰)COOH, and

M⁵ is hydrogen, an alkali metal, an alkaline earth metal or a protonated alkanolamine, e.g. protonated mono-, di- or triethanolamine.

Particularly preferred alkyl-substituted amino acids are the aminopropionates according to formula (XVII),
R¹⁵—NH—CH₂CH₂COOM³ (XVII)
in which R¹⁵ and M³ have the same meanings as in formula (XIV).

Examples of alkyl-substituted amino acids are the following compounds (INCl-identifier): Aminopropyl Laurylglutamine, Cocaminobutyric Acid, DEA-Lauraminopropionate, Disodium Cocaminopropyl Iminodiacetate, Disodium Dicarboxyethyl Cocopropylenediamine, Disodium Lauriminodipropionate, Disodium Steariminodipropionate, Disodium Tallowiminodipropionate, Lauraminopropionic Acid, Lauryl Aminopropylglycine, Lauryl Diethylenediaminoglycine, Myristaminopropionic Acid, Sodium-C₁₂₋₁₅-Alkoxypropyl Iminodipropionate, Sodium Cocaminopropionate, Sodium Lauraminopropionate, Sodium Lauriminodipropionate, Sodium Lauroyl Methylaminopropionate, TEA-Lauraminopropionate And TEA-Myristaminopropionate.

Acylated Amino Acids

Acylated amino acids are amino acids, in particular the 20 natural a-amino acids, which carry the acyl radical R²¹CO of a saturated or unsaturated fatty acid R²¹COOH on the amino nitrogen atom, where R²¹ is a saturated or unsaturated C₆₋₂₂-alkyl radical, preferably C₈₋₂₂-alkyl radical, in particular a saturated C₁₀₋₁₆-alkyl radical, for example a saturated C₁₂₋₁₄-alkyl radical. The acylated amino acids can also be used as alkali metal salt, alkaline earth metal salt or alkanolammonium salt, e.g. mono-, di- or triethanolammonium salt. Examples of acylated amino acids are the acyl derivatives, e.g. sodium cocoyl glutamate, lauroyl glutamic acid, caproyloyl glycine or myristoyl methylanine.

The amphoteric surfactants which are used particularly preferably in the surfactant mixture according to the invention are myristyl- and/or lauryidimethylamine oxide.

The surfactant mixture according to the invention preferably consists in each case of an anionic surfactant and one or two amphoteric surfactants.

In a further preferred embodiment, the surfactant mixture according to the invention consists, in an amount of from 40 to 60% by weight, particularly preferably 45 to 55% by weight, very particularly preferably 50% by weight, of an anionic surfactant and, in an amount of from 40 to 60% by weight, particularly preferably 45 to 55% by weight, very particularly preferably 50% by weight, of an amphoteric surfactant or a mixture of two amphoteric surfactants.

In a further preferred embodiment, the surfactant mixture according to the invention consists of the Na salt of di-2-ethylhexyl sulfosuccinate and myristyl- and/or lauryldimethylamine oxide.

The micelle formation concentration (cmc) of the surfactant mixtures according to the invention in a preferred embodiment of the present invention is <1.0 g/l at 25° C., the micelle formation concentration (cmc) is particularly preferably <0.5 g/l, very particularly preferably <0.1 g/l.

In a further preferred embodiment, the surface tension of an aqueous solution of the surfactant mixture of concentration 1 g/l, measured by the method of maximum bubble pressure at 25° C., after 0.1 s is <45 mN/m, the surface tension is particularly preferably <40 mN/m, very particularly preferably <36 mN/m.

The present invention also relates to a solution consisting of 0.01 to 40% by weight, preferably 0.05 to 10% by weight, particularly preferably 0.05 to 5% by weight, of a surfactant mixture according to the invention consisting of
10 to 90% by weight of at least one anionic surfactant and
10 to 90% by weight of at least one amphoteric surfactant,
   where the sum is 100% by weight, and 60 to 99.99 by weight, preferably 90 to 99.95% by weight, particularly preferably 95 to 99.95% by weight, of water and 0 to 25% by weight, preferably 0 to 20% by weight, particularly preferably 0 to 18% by weight, very particularly preferably 0 to 10% by weight, of an additive chosen from the group consisting of salts, complexing agents, pH regulators, solvents, such as isopropanol, ethanol or butyl diglycol ether, dyes, fragrances and mixtures thereof, where the sum of surfactant mixture, water and optionally an additive is in each case 100% by weight. The solution according to the invention preferably consists exclusively of the surfactant mixture and water.

A surfactant mixture consisting of an isotridecanol ethoxylated with 3 to 7, preferably 5, equivalents of ethylene oxide, and myristyl- and/or lauryldimethylamine oxide has the properties advantageous according to the invention with regard to high wetting rate and improvement in adsorption at interfaces.

The present invention therefore also provides a surfactant mixture consisting of 30 to 50% by weight, preferably 35 to 45% by weight, particularly preferably 40% by weight, of isotridecanol which is ethoxylated with 3 to 7, preferably 5, equivalents of ethylene oxide, and 50 to 70% by weight, preferably 55 to 65% by weight, particularly preferably 60% by weight, of myristyl- and/or lauryldimethylamine oxide, where the sum is in each case 100% by weight.

The isotridecanol used according to the invention which is ethoxylated with 3 to 7, preferably 5, equivalents of ethylene oxide can be prepared by processes known to the person skilled in the art.

Furthermore, the present invention also provides the use of surfactant mixtures consisting of
10 to 90% by weight, preferably 40 to 60% by weight, particularly preferably 45 to 55% by weight, very particularly preferably 50% by weight, of at least one anionic surfactant and
10 to 90% by weight, preferably 40 to 60% by weight, particularly preferably 45 to 55% by weight, very particularly preferably 50% by weight, of at least one amphoteric surfactant,

or
10 to 90% by weight, preferably 30 to 50% by weight, particularly preferably 35 to 45% by weight, very particularly preferably 40% by weight, of at least one nonionic surfactant and
10 to 90% by weight, preferably 50 to 70% by weight, particularly preferably 55 to 65% by weight, very particularly preferably 60% by weight, of at least one amphoteric surfactant,
   where the sum in each case is 100% by weight, for reducing the micelle formation concentration, increasing the rate of wetting and improving the adsorption at interfaces in detergents, cleaning compositions, dishwashing compositions, coatings, humectants, emulsions, suspensions, leveling assistants or formulations for the treatment of leather and/or textiles.

Examples of the applications according to the invention are: all-purpose cleaners, textile detergents, spray cleaners, hand dishwashing detergents, for cleaning in the private, industrial and institutional sector, including metalworking, for paper making, humectants, printing plate and print roll cleaners in the printing industry, paints, coatings, adhesives in the paint and film industry, preparation and stabilization of emulsions and during emulsion polymerization, formulations in the textile industry, such as leveling agents or formulations for yarn cleaning or formulations for the production of leather.

According to the present invention, nonionic surfactants which may be used are all surface-active substances or compounds which do not form ions in the aqueous medium.

The following compounds may be specified as examples:
compounds which are formed by alkoxylation of compounds with at least one active hydrogen atom,
alkoxylates of alkylphenols,
block polymers of C₂-C₆-alkylene oxides and
alkyl glycosides.

Preferred nonionic surfactants are water-soluble addition products obtained by addition of from 3 to 30 mol of an alkylene oxide, preferably ethylene oxide or propylene oxide, onto one mole of an organic, hydrophobic compound of aliphatic or alkylaromatic nature having 8 to 24 carbon atoms and at least one reactive hydrogen atom, in particular a reactive hydroxyl, amino, amido or carboxyl group.

Examples of nonionic water-soluble addition products obtained by addition of two or more mole of an alkylene oxide onto one mole of an organic hydrophobic compound are the following:
the addition products of ethylene oxide onto aliphatic, linear or branched, primary or secondary alcohols having more than 8 carbon atoms, which are derived, for example, from tallow or coconut fatty acids, having 3 to 20 ethylene oxide groups;
the addition products of ethylene oxide onto alkylphenols in which the phenols may be mono- or polyalkylated, and the total number of carbon atoms in the side chain(s) is 5 to 18. Specific examples are addition products of one mole of nonylphenol with 8 to 15 mol of ethylene oxide;
the addition products of ethylene oxide onto fatty acid esters, preferably mono fatty acid esters of the sugar alcohols sorbitol and mannitol;
polyglycoloxycarboxylic esters obtained by reacting ethylene oxide with carboxylic acids, the latter being natural fatty acids or synthetic fatty acids from oxidized paraffin wax having 8 to 20 carbon atoms or alkylbenzoic or naphthenic acids having 5 to 18 carbon atoms in the alkyl chain;
the addition products of ethylene oxide onto fatty acylalkanolamides of the type C₇-₁₇-alkyl-CO—NHC₂H₄OH, C₇-₁₇-alkyl-CO—N—(C₂H₄OH)₂;
the addition products of ethylene oxide onto C₈-₁₈-alkyl-, C₈-₁₈-alkenyl- and C₈₋₁₈-alkylarylamines.

A preferred nonionic surfactant is isotridecanol which is ethoxylated with 3 to 7, preferably 5, equivalents of ethylene oxide.

The present invention also provides a cleaning composition comprising a surfactant mixture consisting of 40 to 60% by weight, preferably 45 to 55% by weight, particularly preferably 50% by weight, of the Na salt of di-2-ethylhexyl sulfosuccinate and 40 to 60% by weight, preferably 45 to 55% by weight, particularly preferably 50% by weight, of myristyl- and/or lauryldimethylamine oxide, where the sum is in each case 100% by weight.

The present invention also provides a cleaning composition comprising a surfactant mixture consisting of 30 to 50% by weight, preferably 35 to 45% by weight, particularly preferably 40% by weight, of isotridecanol, which is ethoxylated with 3 to 7, preferably equivalents of ethylene oxide, and 50 to 70% by weight, preferably 55 to 65% by weight, particularly preferably 60% by weight, of myristyl- and/or lauryldimethylamine oxide, where the sum is in each case 100% by weight.

The cleaning compositions according to the invention can, moreover, comprise all ingredients which are suitable and known to the person skilled in the art, for example builders (sequestrants) and cobuilders, pH regulators, such as inorganic or organic acids, inorganic or organic bases and buffer systems, dispersants, soil carriers, thickeners, enzymes, bleach system, hydrotropic compounds as solubility promoters or solubilizers, e.g. urea or alcohols, foam regulators for stabilizing or suppressing foam, skin and corrosion protectants, disinfecting compounds or systems, e.g. those which comprise iodine or which release chlorine or hypochlorous acid, e.g. dichloroisocyanurate, perfume, dyes and biocides, as are disclosed in WO 2001/96508.

### EXAMPLES

### Example 1

Anionic Surfactant/Amphoteric Surfactant Combination

Surprisingly, it has been found that by combining di-2-ethylhexyl sulfosuccinate, Na salt with myristyldimethylamine oxide, the desired effect arises. We observe a reduction in the micelle formation concentration and more rapid coverage of interfaces compared with the individual surfactants. Furthermore, we observe a lowering of the interfacial tension of the aqueous solution of the surfactant mixture compared with hydrophobic liquids, which is attributable to the denser packing of the surfactants, a physical property which has an advantageous effect in washing and cleaning applications. This is illustrated by reference to the following measurements:

Micelle Formation Concentration (T=25° C.):

| | | |
|---|---|---|
| Di-2-ethylhexyl sulfosuccinate, Na salt: | 1 | g/l |
| Myristyldimethylamine oxide | 0.1 | g/l |
| Di-2-ethylhexyl sulfosuccinate, Na salt/ | 0.05 | g/l |
| myristyldimethylamine oxide (1:1) | | |

The dynamics of surfactants for reducing the surface tension at the water/air interface was determined as a function of time by the bubble pressure method (“dynamic surface tension”).

Surface Tension After 0.1 s (Surfactant Concentration 1 g/l); T=25° C.

| | | |
|---|---|---|
| Di-2-ethylhexyl sulfosuccinate, Na salt: | 39 | mN/m |
| Myristyldimethylamine oxide | 40 | mN/m |
| Di-2-ethylhexyl sulfosuccinate, Na salt/ | 33 | mN/m |
| myristyldimethylamine oxide (1:1) | | |

The wetting of hard surfaces was determined as a function of time with a contact angle measuring device by the lying drop method.

Contact Angle [Degrees] as a Function of Time; Surfactant Concentration: 0.2 g/l; T=40° C.

| | Polyethylene | | | Steel | | | Glass | | |
|---|---|---|---|---|---|---|---|---|---|
| | 0.1 s | 1 s | 10 s | 0.1 s | 1 s | 10 s | 0.1 s | 1 s | 10 s |
| Water | 97 | 96 | 96 | 65 | 65 | 65 | 41 | 41 | 40 |
| Di-2-ethylhexyl | 71 | 72 | 72 | 53 | 52 | 51 | 42 | 40 | 37 |
| sulfosuccinate, Na salt | | | | | | | | | |
| Myristyldimethylamine | 56 | 48 | 35 | 45 | 42 | 33 | 43 | 40 | 31 |
| oxide | | | | | | | | | |
| Di-2-ethylhexyl | 40 | 23 | 4 | 26 | 14 | 11 | 18 | 3 | 0 |
| sulfosuccinate, Na salt/ | | | | | | | | | |
| myristyldimethylamine | | | | | | | | | |
| oxide (1:1) | | | | | | | | | |

The interfacial tension relative to olive oil and hexadecane as hydrophobic liquids was determined by the “spinning drop” method.

Interfacial Tension [mN/m]; Surfactant Concentration 1 g/l; T=25° C.

| | Hexadecane | Olive oil |
|---|---|---|
| Di-2-ethylhexyl | 2.2 | 3.5 |
| sulfosuccinate, Na salt | | |
| Myristyldimethylamine oxide | 1.5 | 0.48 |
| Di-2-ethylhexyl | 0.30 | 0.27 |
| sulfosuccinate, Na salt/ | | |
| myristyldimethylamine oxide (1:1) | | |

### Example 2

Nonionic Surfactant/Amphoteric Surfactant Combination

Similar synergistic effects are observed when combining myristyidimethylamine oxide with an industrially prepared ethoxylated isotridecanol (C₁₃-alcohol+5 ethylene oxide). While the micelle formation concentration remains at the level of the nonionic surfactant and thus the prerequisite for the properties associated with the existence of micelles, such as fat dissolution, emulsification and solubilization, continues to be complied with, the dynamics and the effectiveness of the wetting increases considerably. The findings are illustrated by reference to the following tables:

Micelle Formation Concentration (T=25° C.):

| | | |
|---|---|---|
| C₁₃-alcohol + 5 EO: | 0.02 | g/l |
| Myristyldimethylamine oxide | 0.1 | g/l |
| C₁₃-alcohol + 5 EO/ | 0.03 | g/l |
| myristyldimethylamine oxide (4:6) | | |

The dynamics of surfactants for reducing the surface tension at the water/air interface was determined as a function of time by the bubble pressure method (“dynamic surface tension”).

Surface Tension After 0.1 s (Surfactant Concentration 1 g/l); T=25° C.

| | | |
|---|---|---|
| C₁₃-alcohol + 5 EO: | 52 | mN/m |
| Myristyldimethylamine oxide | 40 | mN/m |
| C₁₃-alcohol + 5 EO/ | 33 | mN/m |
| myristyldimethylamine oxide (4:6) | | |

The wetting of hard surfaces was determined as a function of time with a contact angle measuring device by the lying drop method.

Contact Angle [Degrees] as a Function of Time; Surfactant Concentration: 0.2 g/l; T=40° C.

| | Polyethylene | | | Steel | | | Glass | | |
|---|---|---|---|---|---|---|---|---|---|
| | 0.1 s | 1 s | 10 s | 0.1 s | 1 s | 10 s | 0.1 s | 1 s | 10 s |
| Water | 97 | 96 | 96 | 65 | 65 | 65 | 41 | 41 | 40 |
| C₁₃-alcohol + 5 EO | 59 | 46 | 23 | 47 | 32 | 11 | 41 | 19 | 4 |
| Myristyldimethylamine | 56 | 48 | 35 | 45 | 42 | 33 | 43 | 40 | 31 |
| oxide | | | | | | | | | |
| C₁₃-alcohol + 5 EO/ | 40 | 31 | 15 | 35 | 26 | 11 | 23 | 14 | 4 |
| myristyldimethylamine | | | | | | | | | |
| oxide (4:6) | | | | | | | | | |

The interfacial tension relative to olive oil and hexadecane as hydrophobic liquids was determined by the “spinning drop” method.

Interfacial Tension [mN/m]; Surfactant Concentration 1 g/l; T=25° C.

| | Hexadecane | Olive oil |
|---|---|---|
| C₁₃-alcohol + 5 EO | 2.4 | 3.0 |
| Myristyldimethylamine oxide | 1.5 | 0.48 |
| C₁₃-alcohol + 5 EO/ | 1.2 | 0.48 |
| myristyldimethylamine oxide (4:6) | | |

1-12. (canceled)

13. A surfactant mixture consisting of
10 to 90% by weight of at least one anionic surfactant chosen from alkalimetall-, earth alkalimetall- and ammonium salts of di-C₁-C₂₀-alkylsulfosuccinates or di-C₁-C₂₀-alkylphenylsulfosuccinates and
10 to 90% by weight of at least one amphoteric surfactant, where the sum is 100% by weight.

14. The surfactant mixture as claimed in claim 13, wherein the mixture consists of an anionic and one or two amphoteric surfactants.

15. The surfactant mixture as claimed in claim 13, which consists of 40 to 60% by weight of an anionic surfactant and 40 to 60% by weight of an amphoteric surfactant or a mixture of two amphoteric surfactants.

16. The surfactant mixture as claimed in claim 13, which consists of the Na salt of di-2-ethylhexyl sulfosuccinate and myristyl- and/or lauryldimethylamine oxide.

17. The surfactant mixture as claimed in claim 13, wherein the critical micelle formation concentration (cmc) of the mixture is <1 g/l at 25° C.

18. The surfactant mixture as claimed in claim 13, wherein the surface tension of an aqueous solution of the surfactant mixture of concentration 1 g/l is <45 mN/m according to the method of maximum bubble pressure at 25° C. after 0.1 s.

19. A solution consisting of
0.01-40% by weight of a surfactant mixture as in claim 13,
60-99.99% by weight of water and
0-25% by weight of an additive chosen from the group consisting of salts, complexing agents, pH regulators, solvents, dyes, fragrances and mixtures thereof,
where the sum is 100% by weight.

20. A surfactant mixture consisting of 30 to 50% by weight of isotridecanol which is ethoxylated with 3 to 7 equivalents of ethylene oxide, and 50 to 70% by weight of myristyl- and/or lauryldimethylamine oxide, where the sum is 100% by weight.

21. The method of using surfactant mixtures consisting of
10 to 90% by weight of at least one anionic surfactant and
10 to 90% by weight of at least one amphoteric surfactant,
or
10 to 90% by weight of at least one nonionic surfactant and
10 to 90% by weight of at least one amphoteric surfactant
where the sum in each case is 100% by weight, for reducing the critical micelle formation concentration, increasing the rate of wetting and improving the adsorption at interfaces in detergents, dishwashing compositions, coatings, humectants, emulsions, suspensions, leveling assistants or formulations for the treatment of leather.

22. A cleaning composition comprising a surfactant mixture consisting of 40 to 60% by weight of Na salt of di-2-ethylhexyl sulfosuccinate and 40 to 60% by weight of myristyl- and/or lauryldimethylamine oxide, where the sum is 100% by weight.

23. A cleaning composition comprising a surfactant mixture consisting of 30 to 50% by weight of isotridecanol which is ethoxylated with 3 to 7 equivalents of ethylene oxide, and 50 to 70% by weight of myristyl- and/or lauryldimethylamine oxide, where the sum is 100% by weight.

24. The method of using surfactant mixtures consisting of
10 to 90% by weight of at least one anionic surfactant and
10 to 90% by weight of at least one amphoteric surfactant,
or
10 to 90% by weight of at least one nonionic surfactant and
10 to 90% by weight of at least one amphoteric surfactant,
wherein the sum is 100% by weight each, for increasing the rate of wetting in cleaning compositions or formulations for the treatment of textiles.
